(19) United States
(12) Patent Application Publication
(10) Pub. No.: US 2023/0280142 A1
(43) Pub. Date: Sep. 7, 2023

(54) INHIBITED OXIDISER OR INHIBITED EXPLOSIVE FOR USE IN REACTIVE GROUND

(71) Applicant: PROACTIVE GROUND SOLUTIONS PTY LTD, Wangara (AU)

(72) Inventors: Nicholas Grant Bodley, Wembley Downs (AU); Drew Anthony Martin, Kewdale (AU); Marjana Kaker, City Beach (AU); Jeffrey Richard Andrew Anderson, Stockton (AU)

(73) Assignee: PROACTIVE GROUND SOLUTIONS PTY LTD, Wangara (AU)

(21) Appl. No.: 18/003,049

(22) PCT Filed: Jun. 23, 2021
(86) PCT No.: PCT/AU2021/050654

§ 371 Date: Dec. 22, 2022

(30) Foreign Application Priority Data
Jun. 23, 2020 (AU) 2020902091

(51) Int. Cl. F42D 1/10

(52) U.S. Cl. CPC F42D 1/10

(57) ABSTRACT

An apparatus and method for converting uninhibited bulk explosives or oxidiser into inhibited bulk explosives or oxidiser on demand. The apparatus disperses an inhibitor into a stream of bulk explosive/oxidiser during the conveyance between an explosive truck and a blast hole or in preparation of a bulk oxidiser for use in a bulk explosive vehicle.

### FIELD OF THE INVENTION

The present invention relates to the on demand treatment of bulk oxidiser (for making bulk explosives) or bulk explosives for use in reactive ground to prevent premature detonation of the explosives.

### BACKGROUND

In surface mining operations blasting is generally carried out by drilling a pattern of blast holes into a geological formation. The holes are filled with an uninhibited explosive, typically in lose pored solid, liquid or gel form, which is detonated to break up rock of the formation.

After inserting explosives into the holes, the uninhibited explosives can interact with the surrounding lithology when the composition comprises certain reactive substances such as pyrite. The reaction may cause premature detonation of the explosives prior to the intended detonation time.

The explosives to be inserted into the holes can be treated with an inhibitor to prevent an interaction between the explosives and reactive ground which results in premature detonation, misfiring, or other undesired outcomes.

The process for inhibiting explosives currently requires knowledge of the site specific geology prior to dispatching or mixing explosives on site. In other words, the inhibited explosives become inhibited for the conditions of the specific site and cannot be used on other reactive ground sites, unless the other site has the same reactivity.

Typically, bulk uninhibited explosives are treated to become bulk inhibited explosive within a vessel in which the inhibitor is added to/combined with the uninhibited explosives. Once this occurs the whole of the bulk explosives in the vessel is treated separately from uninhibited explosives or their raw materials thereof and additional storage of the inhibited explosives is required. The inhibited explosives cannot be mixed with standard bulk explosives raw materials. Also equipment holding or handling the inhibited explosives needs to be cleaned (eg. washed down) before different explosives or material can be held or handled in that equipment.

If areas in the vicinity of blasting activities are found to be reactive, the entire area is treated as having reactive geology due to the difficulties in the logistics of carrying alternative bulk explosives or having 2 different mobile processing units (MPU)/mobile manufacturing units (MMU). This can result in inhibited bulk explosive being used for non-reactive ground, which is less efficient and/or wasteful of the inhibitor.

US Application 2019/0257,632 discloses a process of making inhibited bulk explosives from uninhibited emulsion matrix 31 (comprising a mixture of fuel oil and aqueous oxidizer solution) and by injecting inhibitor 51 storing in reservoir 50 into the emulsion matrix stored in reservoir 30 using injector 52 to produce only a continuous inhibited bulk explosives in stream 47 which is provided to mixer 60. The teaching of this document exemplifies the problem as it does not obviate the need to 2 MPU/MMUs.

U.S. Pat. No. 6,125,761 depicts a system in which inhibitor is added to an uninhibited emulsion explosive in order to form an inhibited emulsion explosive mixture, which is either mixed off-site and then transported to site or mixed on site and stored on site before insertion into a blast hole. This requires pre-mixed inhibited emulsion explosive to be transported to site or storage containers on site for mixing on site. Adding an inhibitor is an irreversible process such that after an inhibitor is added to an uninhibited emulsion explosive and converted to an inhibited emulsion explosive then it is the only emulsion explosive available for use. Therefore there is no option to selectively decide which explosives (inhibited or uninhibited) are to be inserted into a blast hole once the storage of uninhibited bulk explosive is converted to an inhibited bulk explosive, regardless of whether or not subsequent blast holes have been found to have reactive ground. Further the addition of the inhibitor increases the cost per unit of volume of the explosives and requires 2 MPU/MMU's if loading inhibited or uninhibited bulk explosives from the same bulk explosives plant.

Accordingly, the current situation presents limitations.

Any document, reference, patent application or patent that might be cited in this text is expressly incorporated herein in their entirety by reference, which means that it should be read and considered by the reader as part of this text. That the document, reference, patent application, or patent cited in this text is not repeated herein is merely for reasons of conciseness.

In this specification, where a literary work, act or item of knowledge (or combinations thereof), is discussed, such reference is not an acknowledgment or admission that any of the information referred to formed part of the common general knowledge as at the priority date of the application. Such information is included only for the purposes of providing context for facilitating an understanding of the inventive concept/principles and the various forms or embodiments in which those inventive.

### SUMMARY OF THE INVENTION

According to a first aspect of the invention, there is provided an apparatus for selectively outputting either one at a time of two alternative outputs, the alternative outputs consisting of: an uninhibited bulk explosive and an inhibited bulk explosive, the apparatus comprising:
an outlet for streaming an output of bulk explosive; and
a dispersion means for adding, or not adding, an inhibitor on demand into a stream of uninhibited bulk explosive exiting the outlet so as to convert uninhibited bulk explosive into inhibited bulk explosive when the inhibitor is added during output of the bulk explosive.

In an embodiment the outlet is for streaming the output of bulk explosive into a blast hole. In an alternative the outlet is for streaming the output of bulk explosive into plant or equipment.

According to a second aspect of the invention, there is provided an apparatus for selectively outputting either one at a time of two alternative outputs, the alternative outputs consisting of: an uninhibited bulk explosive oxidiser and an inhibited bulk explosive oxidiser, the apparatus comprising:
an outlet for streaming an output of bulk explosive oxidiser; and
a dispersion means for adding, or not adding, an inhibitor on demand into a stream of uninhibited bulk explosive oxidiser exiting the outlet so as to convert uninhibited bulk explosive oxidiser into inhibited bulk explosive oxidiser when the inhibitor is added during output of the bulk explosive oxidiser.

Typically, the oxidiser is dry or substantially dry, preferably dry ammonium nitrate (dry AN). The dry AN may be in prill or other form.

According to a third aspect of the invention, there is provided a vehicle for producing an inhibiting oxidiser for mixing with at least one other ingredient (such as for example fuel oil) to form an inhibited bulk explosive at the site of use of the inhibited bulk explosive, the vehicle comprising:

a storage for carrying inhibited bulk explosive oxidizer and a storage for the least one other ingredient to the site of a blast hole and a dispersion means for adding the least one other ingredient into to a stream of inhibited bulk explosive oxidiser from the storage so as to convert the stream of uninhibited bulk explosive oxidiser into a stream of inhibited bulk explosive for insertion into a blast hole.

In an embodiment the dispersion means is configured for inhibited bulk explosive oxidizer that is in a dry or substantially dry form.

According to a fourth aspect of the invention, there is provided a device for selectively outputting either one at a time of two alternative outputs, the alternative outputs consisting of: an uninhibited bulk explosive and an inhibited bulk explosive, the device comprising:
a conduit for streaming of a bulk explosive from a receptacle into a blast hole;
the conduit in operative association with means for selectively adding, or not adding, an inhibitor on demand to the stream such that when added the uninhibited bulk explosive is converted to an inhibited bulk explosive.

In the preferred embodiment of the invention, the bulk explosive is Ammonium Nitrate Fuel Oil (ANFO), Heavy ANFO (HANFO), Emulsion blends, Water-gels or bulk oxidiser.

In the preferred embodiment of the invention, the inhibitor comprises zinc oxide or urea or a mixture of zinc oxide and urea.

In an embodiment of the invention, the dispersion means is configured to disperse the inhibitor on demand into the stream of uninhibited bulk explosive.

In an embodiment of the invention, the dispersion means is configured to inject the inhibitor on demand into the stream of uninhibited bulk explosive.

In an embodiment of the invention, the dispersion means comprises a nozzle.

In the preferred embodiment of the invention, the dispersion means is adjacent to the outlet. The dispersion means may also be at an opening of the outlet.

In an embodiment of the invention, the dispersion means is upstream of the opening.

In an embodiment of the invention, the dispersion means is downstream of the opening.

In the preferred embodiment of the invention, the apparatus further comprises a feed to the dispersion means.

In the preferred embodiment of the invention, the dispersion means comprises a control means for feeding the inhibitor to the dispersion means on demand.

In the preferred embodiment of the invention, the control means comprises a valve.

In an embodiment of the invention, the outlet comprises an auger, chute, hopper or suitable conduit.

According to a fifth aspect of the invention, there is provided a method for selectively outputting either one at a time of two alternative outputs, the alternative outputs consisting of: an uninhibited bulk explosive and an inhibited bulk explosive for insertion into a blast hole, the method comprising:
streaming uninhibited bulk explosive from an outlet; and
adding an inhibitor on demand into the stream of uninhibited bulk explosive at the blast hole such that when added the uninhibited bulk explosive is converted to an inhibited bulk explosive.

According to a sixth aspect of the invention, there is provided a method for outputting inhibited bulk explosive into a blast hole, the method comprising:
conveying inhibited bulk explosive oxidizer and fuel oil to the site of a blast hole;
streaming inhibited bulk oxidiser from an outlet; and
adding fuel oil into the stream of inhibited explosive oxidiser so as to produce a stream of inhibited bulk explosive into the blast hole.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DESCRIPTION OF DRAWINGS

In order to provide a better understanding of the present invention embodiments will now be described may be described, by way of example only, with reference to the drawings, in which:

FIG. 1 is a perspective view of a typical explosives truck producing a bulk explosive at the blast hole.

FIG. 2 is a rear cross-sectional view of an alternative embodiment of an on demand explosive inhibiting apparatus.

FIG. 3 is a cross-sectional view of an alternative embodiment of an on demand explosive inhibiting apparatus.

FIG. 4 is a cross-sectional view of an alternative embodiment of an on demand explosive inhibiting apparatus with multiple possible feed locations to dispersion means.

### DETAILED DESCRIPTION

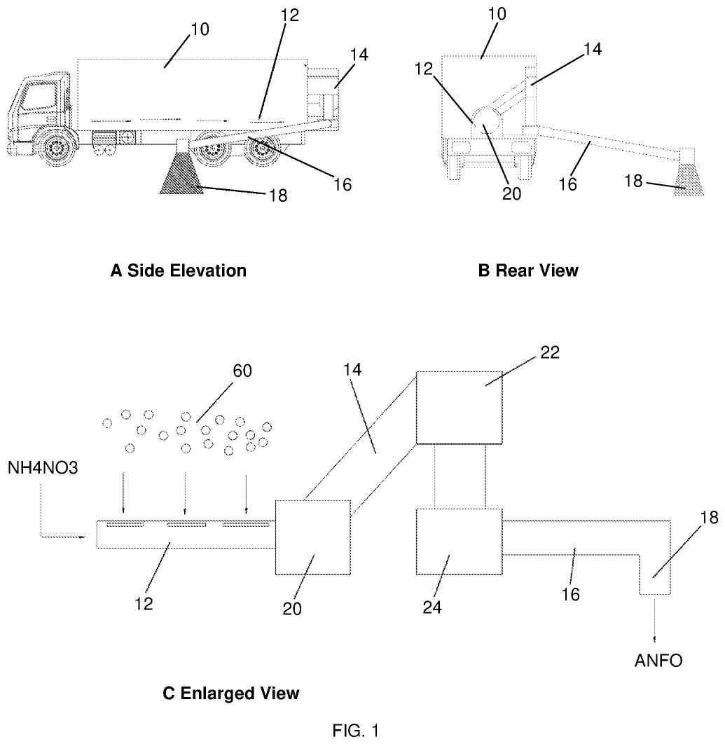

Referring to FIG. 1 there is shown a typical explosives truck 10 comprising a tank, and a belly auger 12 which carries ammonium nitrate (NH₄NO₃) (AN) prill 60 or an alternative oxidiser to be dosed with fuel oil or sensitiser to produce ammonium nitrate fuel oil (ANFO) or another type of explosives (such as HANFO, Ammonium Nitrite Emulsion (ANE), or other bulk explosive). The AN (in this instance) exits the belly auger 12 as a stream into a rear transfer 20. The dosing with fuel oil to produce bulk explosive typically occurs somewhere between the vertical transfer 14 and the swivel of the auger 24. The explosive then enters a second transfer 22 to a side auger 16 which is attached at a swivel 24 that provides means for articulating of the side auger 16 to manoeuvre an output 18 to dispense the explosives into a blast hole.

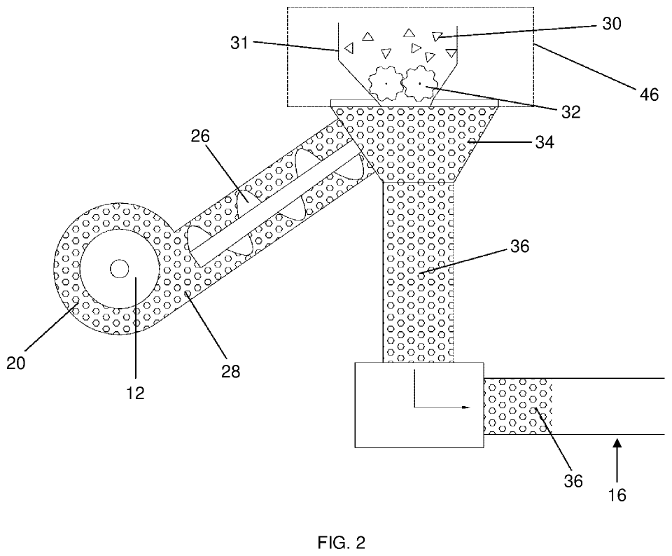

Referring to FIG. 2 a rear cross-sectional view of an on demand explosive inhibiting apparatus 46 installed or fixed externally by any means to the explosives truck, mobile manufacturing unit (MMU) or mobile processing unit (MPU) 10. The belly auger 12 provides uninhibited bulk oxidiser 28 through the belly auger 12 as a stream through a rear transfer 20 continuing on through an inclined auger 26. Uninhibited bulk oxidiser is streamed from the auger 26 into to a transfer junction 34 where an on demand explosive inhibiting apparatus 46 is in operative association with the transfer junction 34 by way of a dispersion means. An inhibitor 30 is inserted into a feed 31 which is in operative association with a dispersion means. In an embodiment, the inhibitor 30 comprises zinc oxide, urea or a mixture of zinc oxide and urea. In this embodiment of the invention, the inhibitor 30 is inserted into the feed 31 and is further crushed by a rotary or conical crusher 32 to assist in breaking down the inhibitor 30 into smaller particles if required which are more suitable for adding to the stream of uninhibited bulk oxidiser 28. The stream of uninhibited bulk oxidiser 28 mixes with the inhibitor 30 to convert to a stream of inhibited bulk oxidiser 36 is then streamed from the transfer junction 34 through the side auger 16 to the output 18 positioned for inserting the stream of uninhibited 28 or inhibited bulk oxidiser 36. The same process can be used can be used on bulk explosives (such as when fuel oil has been added to the oxidiser) so as to form uninhibited 28 or inhibited bulk explosives for streaming directly into the borehole.

The on demand ability in this embodiment is apparent when the crusher 32 is turned on or off or when inhibitor 30 is inserted into the feed 31 or left empty. In the instance where the rotary or conical crusher 32 is turned on and the feed 19 has inhibitor 30 loaded and available for dispersion, the inhibitor 30 will be dispersed by the dispersion means into the stream of uninhibited bulk explosives at the transfer junction 34 to convert the stream of uninhibited bulk oxidiser 28 to a stream of inhibited bulk explosive 36 for insertion into the blast hole. In the instance that the rotary, jaw, pin, conical or crusher of any sort 32 is turned off or there is no inhibitor 30 inserted into the feed 31, a negligible amount or no inhibitor 30 will be added by the dispersion means throughout the stream of uninhibited bulk explosive 28 at the transfer junction 34. Negligible in this context means substantially low such that it is unable to convert the stream of uninhibited bulk oxidiser 28 into a stream of inhibited bulk explosive 36. Accordingly, a stream of uninhibited bulk oxidiser 28 or a stream of inhibited bulk explosive 36 can be produced without needing to dose the uninhibited bulk oxidiser 28 prior to arriving at site or on site converting the entire supply of uninhibited bulk oxidiser 28 to an inhibited bulk explosive 36. Using inhibitor 30 to convert the uninhibited bulk oxidiser 28 stream to an inhibited bulk explosive stream could be selectively done only on blast holes which contain reactive ground. Otherwise the stored uninhibited bulk oxidiser 28 will be used for blast holes that do not contain reactive ground.

It should be appreciated by the skilled address that there are various other methods for producing the on demand feature. For example, a valve could separate the feed 31 with the inhibitor 30 from each of a dispersion means such that the valve can be opened or close. The valve in the open position would allow dispersion of the inhibitor 30 into the stream of uninhibited bulk oxidiser 28 converting it into a stream of inhibited bulk oxidiser 36. The valve in the closed position would not provide inhibitor 30 through the dispersion means preventing the uninhibited bulk oxidiser 28 from converting to an inhibited bulk oxidiser 36 as it is streamed through the transfer junction 34, which is in operative association with the apparatus 46, and then fuel oil can be added to form bulk explosive for insertion into the blast hole.

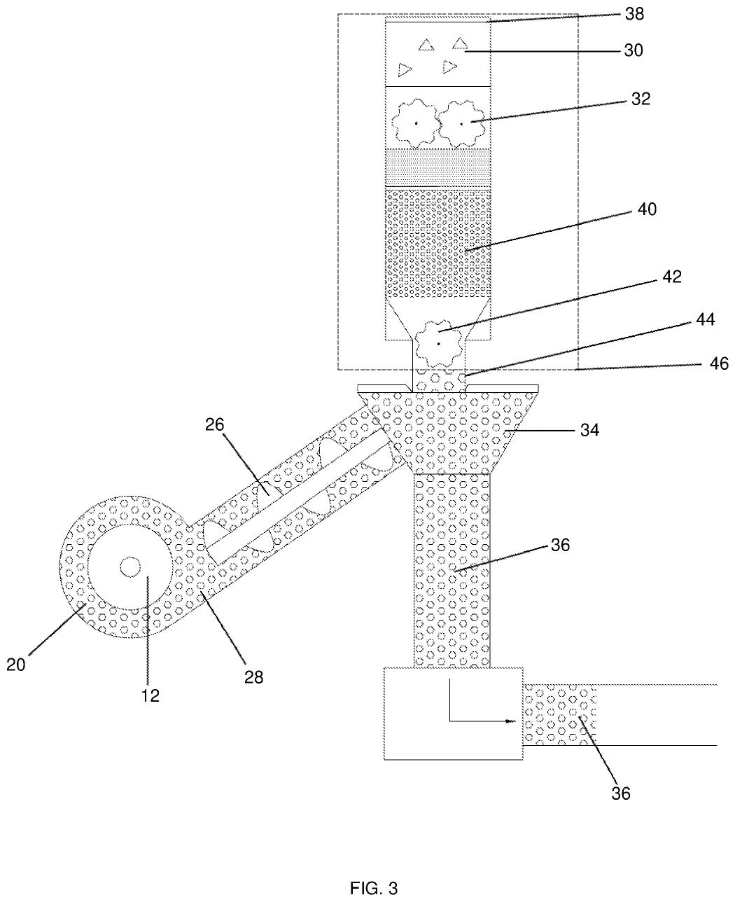

Referring to FIG. 3 an alternative embodiment similar to FIG. 2 is shown wherein an alternate on demand explosive inhibiting apparatus 46 is attached at the transfer junction 34 comprising the dispersion means. The on demand explosive inhibiting apparatus 46 is mounted in a suitable location such that the inhibitor 30 can be conveyed through a transfer hose 44 with the assistance of gravity, pneumatically or by some other means 42 to the transfer junction 34 comprising the dispersion means. The mixture of the stream of uninhibited bulk oxidiser 28 and crushed inhibitor 40 are further mixed through gravity and/or agitation as the stream of uninhibited bulk oxidiser 28 is streamed through the transfer junction 34 and converted by adding fuel oil into a stream of inhibited bulk explosive 36 which is conveyed through the side auger 16 to the output 18 and inserted into the blast hole.

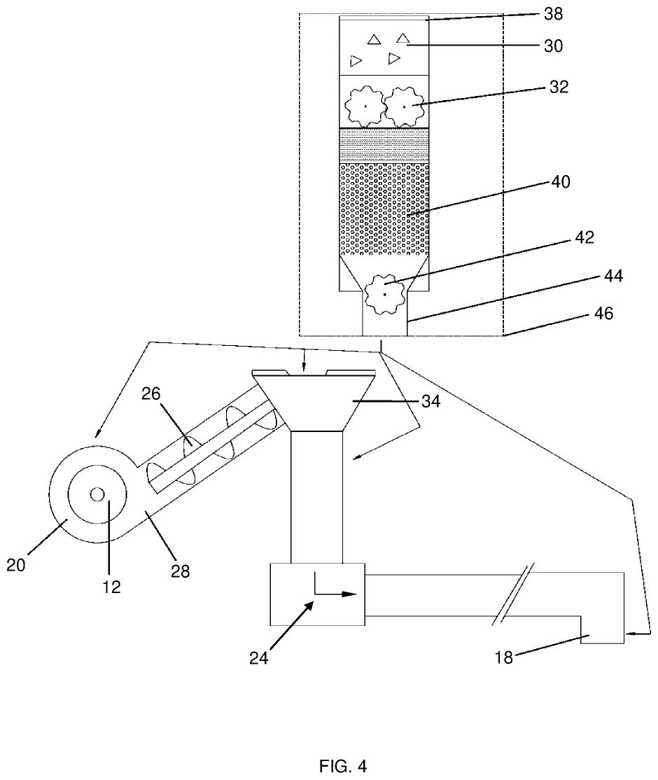

Referring to FIG. 4 a further alternative embodiment similar to FIG. 3 is shown wherein an alternate on demand explosive inhibiting apparatus 46 is affixed to the transfer junction 34 comprising the dispersion means for adding inhibitor 30 to a stream of uninhibited bulk oxidiser 28 whereby the inhibitor 30 converts the stream of uninhibited bulk explosive 28 to a stream of inhibited bulk explosive 36 for insertion into a blast hole. In this embodiment inhibitor 30 is dispersed into the stream of uninhibited bulk oxidiser 28 at four alternative points between the belly auger 12 and the output 18.

A first dispersion point disperses the inhibitor 30 from a transfer hose 44 with the assistance of gravity, pneumatically or by some other means 42 to a dispersion means located at the rear transfer 20. A second dispersion point disperses inhibitor 30 from the transfer hose 44 to a dispersion means located at the transfer junction 34. A third dispersion point disperses inhibitor 30 from the transfer hose 44 to a dispersion means at a point between the transfer junction 34 and the swivel 24. A fourth dispersion point disperses the inhibitor 30 from the transfer hose 44 to a dispersion means at the output 18.

The skilled addressee will appreciate that other suitable points for adding or locating dispersing means for adding inhibitor 30 to the stream of uninhibited bulk oxidiser 28 or a stream of uninhibited bulk oxidiser 28 in the process of being converted to a stream of inhibited bulk explosive 36 are envisaged in this invention. Furthermore, the skilled addressee will also appreciate that the invention anticipates any number of dispersion means being added to the system for selectively adding inhibitor 30 to the stream of uninhibited bulk oxidiser 28 or a stream of uninhibited bulk oxidiser 28 in the process of being converted to a stream of inhibited bulk explosive 36.

The skilled person will also appreciate that the inhibitor may be in granular, power, emulsion or dissolved liquid form. Preferably it will be in granular form.

Modifications may be made to the present invention within the context of that described and shown in the drawings. Such modifications are intended to form part of the invention described in this specification.

1. An apparatus for selectively outputting either one at a time of two alternative outputs, the alternative outputs consisting of: an uninhibited bulk explosive or oxidiser and an inhibited bulk explosive or oxidiser comprising:
an outlet for streaming an output of bulk explosive; and
one or more dispersion means for adding, or not adding, an inhibitor on demand into a stream of uninhibited bulk explosive exiting the outlet so as to convert uninhibited bulk explosive into inhibited bulk explosive when the inhibitor is added during output of the bulk.

2. An apparatus for selectively outputting either one at a time of two alternative outputs, the alternative outputs consisting of: an uninhibited bulk explosive oxidiser and an inhibited bulk explosive oxidiser, the apparatus comprising:
an outlet for streaming an output of bulk explosive oxidiser; and
a dispersion means for adding, or not adding an inhibitor on demand into a stream of uninhibited bulk explosive oxidiser exiting the outlet so as to convert uninhibited bulk explosive oxidiser into inhibited bulk explosive oxidiser when the inhibitor is added during output of the bulk explosive oxidiser.

3. An apparatus according to claim 12, wherein the inhibitor added is or substantially is dry.

4. An apparatus according to claim 1, wherein the dispersion means is adjacent to or at the outlet.

5. An apparatus according to claim 1, wherein the dispersion means is upstream of the outlet.

6. An apparatus according to claim 5, wherein the uninhibited bulk explosive or oxidiser and the inhibited bulk explosive or oxidiser further comprises a feed to the dispersion means.

7. An apparatus according to claim 1, wherein the dispersion means comprises a control means for feeding the inhibitor to the dispersion means on demand.

8. An apparatus according to claim 7, wherein the control means comprises a valve.

9. A vehicle for producing an inhibited bulk explosive at the site of use of the inhibited bulk explosive, the vehicle comprising:
a storage for carrying inhibited bulk explosive oxidizer and a storage for the least one other ingredient to the site of a blast hole and a dispersion means for adding the least one other ingredient into a stream of inhibited bulk explosive oxidiser from the storage so as to convert the stream of inhibited bulk explosive oxidiser into a stream of inhibited bulk explosive for insertion into a blast hole.

10. A vehicle according to claim 9, wherein the dispersion means is configured for inhibited bulk explosive oxidiser that is in a dry or substantially dry form.

11. A device for selectively outputting either one at a time of two alternative outputs, the alternative outputs consisting of: an uninhibited bulk explosive and an inhibited bulk explosive, the device comprising:
a conduit for streaming of a bulk explosive from a receptacle into a blast hole;
the conduit in operative association with means for selectively adding, or not adding, an inhibitor on demand to the stream such that when added the uninhibited bulk explosive is converted to an inhibited bulk explosive.

12. A device according to claim 11, wherein the inhibitor is added directly into the stream.

13. A method for selectively outputting either one at a time of two alternative outputs, the alternative outputs consisting of: an uninhibited bulk explosive and an inhibited bulk explosive for insertion into a blast hole comprising:
streaming uninhibited bulk explosive from an outlet; and
adding, or not adding, an inhibitor on demand into the stream of uninhibited bulk explosive at the blast hole such that when added the uninhibited bulk explosive is converted to an inhibited bulk explosive.

14. The method of claim 13, wherein the uninhibited bulk explosive is streamed from the outlet directly into the blast hole.

15. A method for outputting an inhibited bulk explosive comprising:
conveying inhibited bulk explosive oxidiser and fuel oil to the site of a blast hole;
streaming inhibited bulk oxidiser from an outlet; and
adding fuel oil into the stream of inhibited explosive oxidiser so as to produce a stream of inhibited bulk explosive into the blast hole.

16. A method according to claim 15, wherein the fuel oil is added into the stream as the inhibited bulk oxidiser is streamed from the outlet directly into the blast hole.

17. An apparatus according to claim 1 wherein, the output streams bulk explosive directly into the blast hole.

18. A vehicle according to claim 9, wherein the stream of inhibited bulk explosive is output directly into the blast hole.

19. A vehicle according to claim 9, further comprising a controller for adding the other ingredient to the stream of the inhibited bulk explosive oxidizer in a controlled manner to produce inhibited explosive on demand as it is inserted into the blast hole.
